(19) United States
(12) Patent Application Publication
(10) Pub. No.: US 2009/0121168 A1
(43) Pub. Date: May 14, 2009

(54) VALVE

(75) Inventors: Paul Muzzo, Yutz (FR); Paul Kremer, Helmsange (LU)

Correspondence Address: CANTOR COLBURN, LLP, 20 Church Street, 22nd Floor, Hartford, CT, 06103, US

(73) Assignee: LUXEMBOURG PATENT COMPANY S.A., Lintgen (LU)

(21) Appl. No.: 12/299,450

(22) PCT Filed: May 4, 2007
(86) PCT No.: PCT/EP2007/054343

§ 371 Date: Jan. 13, 2009

(30) Foreign Application Priority Data
May 4, 2006 (EP) 06113528.1

(51) Int. Cl. F16K 35/00

(52) U.S. Cl. 251/89.5

(57) ABSTRACT

Valve for pressurized or liquefied gas cylinder comprising a valve body (12) with a gas flow passage (16) running between an inlet opening (18) and an outlet opening (20); and a sealing seat (30) inside the passage (16) of the valve body with which a plugging member (34) is associated. A control head (14, 114) is mounted removably on the valve body (12) and includes an axial control rod (60, 118) cooperating with the plugging member (34) in order to move it between a closed position in which it rests on the sealing seat (30), in order to block the flow into the passage (16), and an open position in which the plugging member (34) is separated from the sealing seat (30), in order to enable the outflow. A locking means (82) is integrated with the valve body (12) and enables the plugging member (34) to be locked onto the sealing seat (30) when the control head (14, 114) is separated from the valve body (12).

### FIELD

The disclosure relates to a valve or valve, especially for liquefied gas or gas cylinder (or bottle). This valve is particularly well adapted for applications using ultra pure gases.

### BACKGROUND

The increasingly widespread use of special gases and the high level of purity demanded today by certain industries results in continual efforts by manufacturers of valves, valves and other gas distribution equipment to improve the quality and integrity of their products.

For the semiconductor industry for example, high-quality gas distribution systems have been developed since the presence of impurities in the gases could irreparably affect the electrical properties of the components and therefore also affect production efficiency. Furthermore, these gases are expensive, highly reactive, corrosive and/or toxic and it is therefore imperative to have suitable and reliable equipment.

Though the number of users of special gases may be relatively significant, there are not many sites for manufacturing such gases and they may be very distant from the users. In practice, this adds significant logistical costs to the actual costs related to the gas and to the special equipment (cylinder and valves in particular).

Today, cylinders for special gases are equipped, when they leave the factory, either with manually controlled valves, or with pneumatically controlled valves, depending on the requirements of the customers/users. It often happens that one and the same factory, for example for producing semiconductors, simultaneously uses cylinders equipped with manual and pneumatic controls. A situation with which the user is frequently confronted is that the gas that he wishes to use is contained in a cylinder equipped with a manually controlled valve, while the installation in which he would have wanted to use it requires a pneumatic control, or vice versa. Furthermore, certain cylinders equipped with one type of control are reshipped partially refilled to the gas production site (or the distributer) since they cannot be used with another application which requires another type of valve control. Finally, a gas producer or distributer is confronted with the same problem, since he must extend his pool of cylinders for gas of high purity so that he has a permanent stock of cylinders equipped with manually controlled and pneumatically controlled valves, so as to be able to satisfy the requirements of his customers.

### BRIEF DESCRIPTION

In order to remedy the abovementioned problems, the present disclosure proposes a valve, especially for pressurized or liquefied gas cylinder, comprising a valve body with a gas flow passage extending between an inlet port and an outlet port. A sealing seat is arranged in the valve body passage, with which a obturating member is associated. Typically, the sealing seat is situated in a valve chamber in the gas passage, and the obturating member is generally mobile inside this chamber. A control head is mounted on the valve body and comprises an axial control rod cooperating with the obturating member so as to control its displacement between a closure position in which it rests on the sealing seat so as to block the flow in the passage and an opening position in which the obturating member is parted from the sealing seat to allow the flow of the gas in the passage.

According to an important aspect of the disclosure, the control head is mounted in a removable manner on the valve body. Furthermore, a locking means comprising a stop member that is mobile outside the gas passage is integrated into the valve body, this locking means allowing the locking of the obturating member on the sealing seat when the control head is separated from the valve body, doing so when there is a pressurized gas in the cylinder on which the valve is mounted.

It will be noted that the mobile stop member being mounted mobile outside the gas passage, it is not wetted by the gas, thus avoiding any contamination of the fluid passing through the valve. The mobile stop member, which may for example be arranged in a zone of the valve body intermediate between the valve chamber and the control head, is able to act directly or indirectly on the obturating member so as to lock it on the sealing seat.

Advantageously, and as is typically the case for applications of high-purity gas, the valve chamber is closed in a sealed manner towards the control mechanism by an exterior sealing means.

The present disclosure therefore relates to a valve whose control head is detachable from the valve body, thereby making it possible to change control head and especially to replace a manual control head by a pneumatic control head, or one based on another actuating principle. The presence of the locking means integrated into the valve body is particularly worthwhile since it makes it possible to lock the control member on the sealing seat when the control head is separated from the valve body, thereby enabling the control head to be changed while the cylinder (or the system on which the body is mounted) is pressurized.

The valve therefore allows greater flexibility in managing stocks or pools of cylinders, both for gas manufacturers or distributers and also for users. Within a very short space of time a gas worker can change a control head, while the cylinder is pressurized, without any risk of gas escaping.

Various embodiments are conceivable for the locking means depending on the design of the valve body. Certain preferred characteristics of such a locking means are cited below.

The locking means is preferably designed to influence the operation of the valve only in a so-called “active” position, in which the obturating member is locked on the sealing seat. When locking is not desired, the locking means can be placed in the rest position, in which it does not act on the obturating member.

The stop member of the locking means can take diverse forms, the objective being to be capable of activating it selectively so as to block the obturating member on its seat. According to a variant, the stop member of the locking means is axially displaceable, outside of the gas flow passage, between an active position and a rest position. This stop member can take the form of a sleeve which comprises on its exterior lateral surface a thread cooperating with a thread on a fixed part of the valve body, so that when the sleeve is rotated on the thread, it moves towards or away from the obturating member.

For safety reasons, the locking means is advantageously designed so that the control head can be removed only when the locking means is in the active position, with the obturating member in the closure position. It is possible for example to use fixing screws (or other removable fixing means) to fix the control head to the valve, which screws are hidden when the locking mechanism is in the active position and are accessible for removal in the rest position.

For safety reasons also, a coupling which is rigid in the axial direction, and separable, is advantageously provided between the control rod and the obturating member. A valve with a so-called “tied” valve is therefore obtained: that is to say a displacement of the control rod necessarily causes a displacement of the obturating member. Advantageously, the coupling between the control rod and the obturating member is effected outside the zone wetted by the gases, that is to say outside the gas passage, therefore typically outside the valve chamber, beyond the exterior sealing.

In a preferred variant, the obturating member comprises a valve fixed at the end of a valve rod guided axially with respect to the sealing seat in a longitudinal bore of the valve body. In this case, the stop member preferably surrounds the valve rod and can be displaced axially into the active position in which it acts directly on the rod or the valve.

For the tying of the valve, the valve rod advantageously comprises at its end opposite from the valve an outside thread which cooperates with a thread in a cylindrical housing of the control rod. Such coupling makes it possible, when the control rod moves axially, to transmit the axial movement to the valve rod. Furthermore, if the control rod is pivoted on itself and the valve rod is locked in rotation, this type of coupling makes it possible to generate an axial displacement of the valve rod. The valve can therefore be controlled axially by a rotary control rod (e.g. in a manual control head) or by a control rod moving axially (typically with a pneumatic control head).

For its actuation, the locking mechanism preferably comprises a wheel surrounding the valve body, on the side of the valve rod and the control head. The wheel is coupled to the axial stop member in such a way that a rotation of the wheel (typically over a portion of a revolution) around the valve body generates an axial displacement of the stop member. According to a variant, the wheel is fixed by screws on a splined crown which engages in splines on the exterior periphery of the stop member-like sleeve. The wheel is secured to the splined crown by way of screws which pass through the valve body at the level of guidance slots (generally in a plane perpendicular to the axis of the control rod) which define the travel of said wheel around the valve body.

The wheel can comprise a series of openings which are positioned so as to be aligned (coincide) with means for fixing the control head to the valve body, when removing the head, and so as to hide these fixing means in the rest position of the locking means.

According to one execution, the valve body comprises a connector-like piece receiving the control head. The wheel surrounds the connector-like piece; the splined crown is placed in the connector-like piece and the guidance slots are provided in the connector-like piece. The control head is fixed in a removable manner to this connector-like piece, which can be made integral with the valve body or be fixed to the latter, for example by screwing.

The control head can be of the manually or remotely actuated type, for example pneumatic. Specifically, any type of mechanism allowing the control rod to be displaced axially can be envisaged for the actuation head.

When a control head of the pneumatic type with prestress springs is used, it advantageously comprises a locking mechanism to lock the prestress springs in a compressed position. This prevents the springs from deploying to the maximum when the actuation head is separated from the valve body.

As will have been understood, the valve finds a particularly advantageous application in the guise of cylinder valve for pressurized gas of ultra-high purity. The valve body is then designed to be fixed to a cylinder and the inlet port of the flow channel typically emerges inside the cylinder. Nevertheless, the present valve can also be used as flow valve in a (fluid) gas distribution system. In this case, the valve body will preferably be adapted so that the inlet and outlet ports can be linked up to the pipes or other elements of the gas distribution system.

### BRIEF DESCRIPTION OF THE DRAWINGS

Other features and characteristics of the disclosure will emerge from the detailed description of a few advantageous embodiments presented below, by way of illustration, while referring to the appended drawings. The latter show:

FIG. 1: a view in longitudinal section of a preferred embodiment of a valve, with a manual control head;

FIG. 2: an exploded view of the locking means integrated into the connector part of the valve body;

FIG. 3: a view in longitudinal section of the valve body of FIG. 1, equipped with a pneumatic control head;

FIG. 4: a view in perspective of the valve body minus control head;

FIGS. 5 and 6: a view in perspective of the valve of FIG. 1, respectively of FIG. 3.

### DETAILED DESCRIPTION

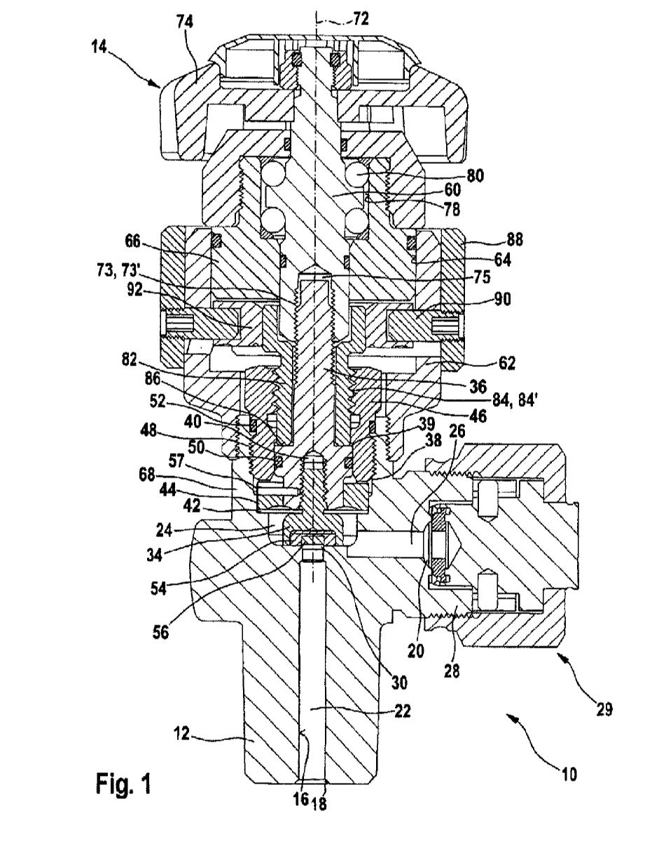

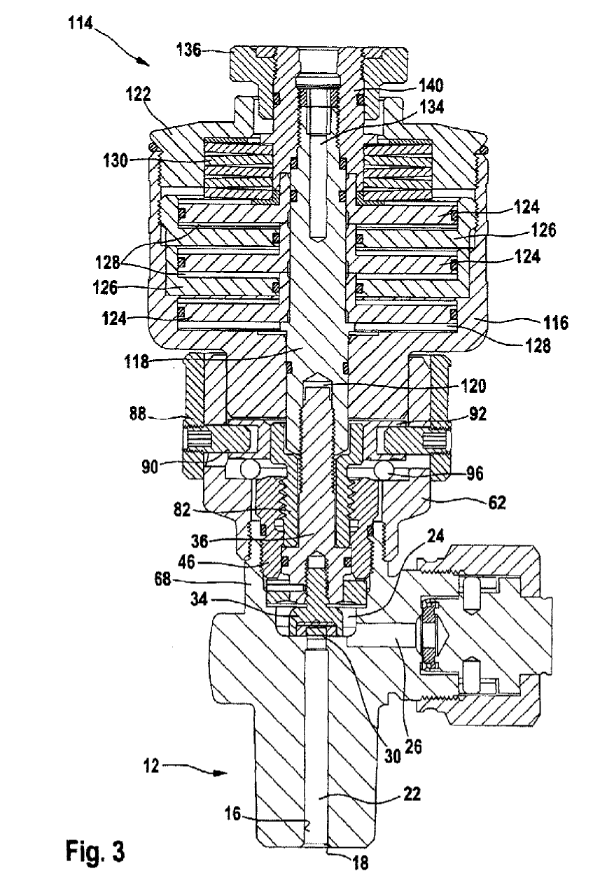

FIG. 1 illustrates a view in longitudinal section of a preferred embodiment of the present valve 10, which comprises a valve body and a control head designated in a general manner 12 and 14 respectively. In the variant of FIG. 1, the control head 14 is of the manually actuated type although in that of FIG. 3, the head, indicated 114, is of the pneumatic type. As will be explained in greater detail below, the control head 14, 114 is mounted in a removable manner and can be separated from the valve body 12 while the latter is fixed to a pressurized cylinder. This therefore makes it possible to exchange one control head for another, whose actuating principle may be different. The replacement of the control head 14, 114 while the cylinder is pressurized is made possible in particular by the presence of a locking mechanism in the valve body able to act selectively on the obturating member so as to lock it in the closure position.

The valve body 12 is designed to be screwed onto a gas cylinder (not shown) and comprises a gas flow passage 16 which extends between a gas inlet port 18 and a gas outlet port 20. In the present execution, the flow passage 16 is formed by an inlet passage 22 linking the inlet port 18 to a valve chamber 24 and an outlet passage 26 linking the valve chamber 24 to the outlet port 20. The inlet passage 22 passes through the lower part of the body 12, which is furnished with a thread (not represented) allowing the valve to be screwed onto the cylinder. For its part, the outlet passage 26 emerges at the end of a portion forming a union 28 equipped with a removable union 29.

The end of the inlet passage 22 emerging in the chamber 24 forms a sealing seat 30 with which a obturating member cooperates so as to allow the flow towards the outlet passage 26 or to plug the passage 16 in a sealed manner. The obturating member comprises a valve 34 which is preferably secured to a valve rod 36 which passes through a longitudinal bore 38 in the upper part 68 of the valve body 12. By axial displacement of the valve rod 36, the valve 34 can therefore be displaced between a closure position (FIG. 1) in which it rests on the sealing seat and closes the passage 16 in a sealed manner, and an opening position separated from the seat 30 in the chamber 24, in which the gas can flow towards the outlet passage 26. For its fixing to the valve rod 36, the valve 34 comprises a threaded rod portion which is screwed onto a thread of the inside surface of a housing 40 at the end of the valve rod 36.

The sealing of the chamber 24 on the outside, that is to say on the side of the valve rod 36 and at the level of the longitudinal bore 38, is achieved in a conventional manner by a flexible membrane 42 (plastic or metallic). As seen in FIG. 1, this membrane 42 surrounds the valve rod 36 and closes the chamber 24 on the side of the bore 38 where it is held by a mount 44, itself held by a packing 46 solidly fixed by screwing (threads labeled 48) in the bore 38. It will also be noted that the packing 46 preferably comprises a shoulder 39 limiting the axial displacement of the valve rod 34 in the opening direction. The references 50 and 52 indicate two O-ring seals. In a conventional manner also, the valve 34 can comprise, facing the seat 30, a cavity in which are arranged a pad 54 and a stopper 56. Finally, the valve rod 36 is locked in rotation by a pin 57 guided axially in the mount 44. Although the exterior sealing of the valve chamber 24 is achieved here by a flexible membrane 42, it is clear to the person skilled in the art that means of exterior sealing of diverse constructions can be employed to achieve such sealing, with or without flexible membrane, the objective being to ensure the sealing of the chamber 24 on the outside (valve rod 36 side, towards the control head 14).

The control head 14 is mounted, removably, on the valve body 12 and comprises a control rod 60 for actuating the valve rod 36 and therefore the valve 34. In the present variant, the control head 14 is received in an intermediate body 62, also called a connector, of the valve body 12. The connector 62 has a generally tubular form and defines a cylindrical housing 64 in which the lower part of the body 66 of the control head 12 is received. The connector 64 is here designed as an independent piece and is screwed by its lower part onto the upper portion 68. In the assembled configuration of FIG. 1, the control head 14 is fixed to the connector 62 by way of screws (not represented) whose head is housed in the connector 62 and the threaded rod penetrates into the body 66 of the control head 14.

It will be appreciated furthermore that the control rod 60 is rigidly coupled to the valve rod 36, so that an axial movement (along axis 72) of the control 60 necessarily causes a displacement of the valve 34. For this purpose, the end of the rod 36 opposite from the valve is furnished with an outside thread 73 and will be screwed onto an inside thread 73′ in a cylindrical housing 75 in the control rod 60. Such a valve 34 is termed “tied”.

In the present variant, the design of the control head 14 is such that the control rod 60 is locked axially and can therefore only rotate around the axis 72 when the wheel 74 to which it is secured is actuated by its upper end. Locking in the axial direction is obtained by a radial protuberance 76 of the rod 60 at the level of a cavity 78, in which the protuberance 76 is locked between balls 80, therefore only allowing the rod 60 to rotate on itself.

The control rod 60 being axially locked, it will be understood that the maneuvering of the wheel 74 causes a rotation of the rod 60 and of its thread 73′, which consequently causes the axial displacement of the valve rod 36 (locked in rotation). It will be noted here that though other types of couplings can be envisaged to tie the valve to the control rod, the present embodiment allows axial displacement of the valve, either by rotation of the control rod 60 as explained previously, or simply axial displacement of the control rod with a control head of another type.

As indicated above, a means for locking the valve 34 is integrated into the valve body 12. In the present variant, it comprises an axially displaceable sleeve 82, which constitutes a sort of retractable stop member. More precisely, the sleeve 82 extends in the bore 38 and in the union 62. The sleeve 82 comprises an outside thread 84 which cooperates with an inside thread 84′ of the packing 46, the rotation of the sleeve 82 consequently causing an axial displacement of the latter upwards or downwards, depending on the direction of rotation. In FIG. 1, the valve 34 is in the closure position on its seat 30 and the sleeve 82 is in stop member against a shoulder 86 of the valve rod 36, thus preventing any displacement of the rod 36 and therefore preventing the separation of the valve 34 from its seat 30. In this configuration, the locking means is said to be in the active position.

In this active position, the axial displacement of the valve rod 36 and of the valve 34 are prevented by the sleeve 82, which also renders the control head inactive. It will therefore be understood that, in the active position of the locking means, the control head 14 can be removed without this having any influence on the closing of the cylinder, and therefore without any risk of gas leaks.

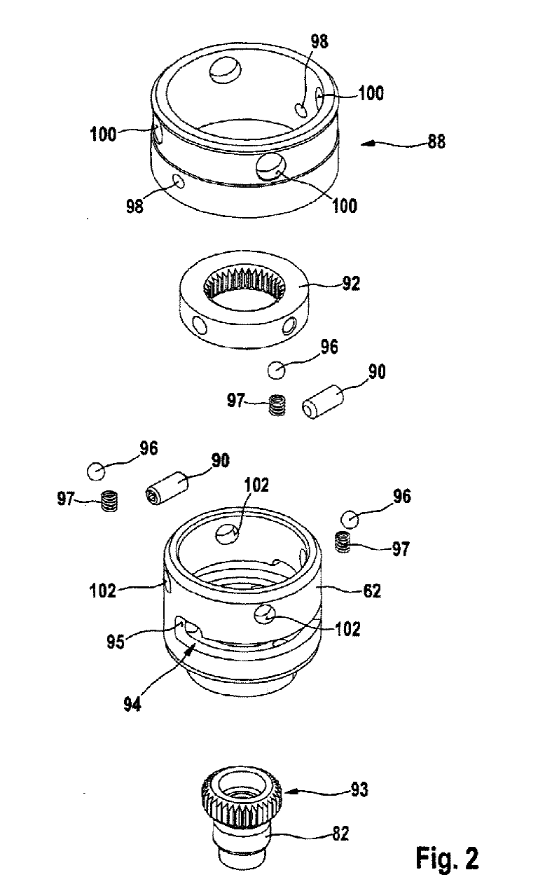

To maneuver (axial positioning) the sleeve 82, the locking means advantageously comprises a wheel 88 at the periphery of the connector 62 which is fixed by screws 90 to a splined crown 92, which is engaged with exterior splines 93 provided in the upper part of the sleeve 82. As will be better understood in FIG. 2, the fixing screws 90 are two in number and are diametrically opposed. Each screw 90 has its head housed in the wheel, passes through the connector 62 and is screwed into the splined crown 92. It will be noted that the connector 62 comprises two guidance slots 94 extending in a plane essentially perpendicular to the axis 72. By rotating the wheel 88 with respect to the valve body 12, the splined crown 92 is thus driven and this causes the rotation of the sleeve 82 and therefore its axial displacement on the packing 46. The amplitude of the axial displacement of the sleeve 82 depends on the pitch of the threads 84, 84′ and the angular travel of the wheel 88 (here of the order of 120°). The splines are beneficial in that they allow rotational driving of the sleeve 82 while permitting its axial displacement.

Each guidance slot 94 can define at one of its ends, or at both, a clearance 95 allowing the locking of the wheel in the active and/or rest position (in which the sleeve is set back on the thread 84′ and does not oppose the movements of the obturating member). The reference signs 96 and 97 respectively indicate balls and springs which are positioned under the splined crown 92 and bear on the bottom of the connector 62 so as to facilitate the rotation of the crown 92 and generate an upward restoring force helping the locking in the clearances 95.

Referring again to FIG. 2, it will be noted that the wheel 88 comprises two series of holes 98 and 100. The holes 98 are two in number, diametrically opposed, and receive the heads of the screws 90 for fixing to the splined crown 92. The holes 100, in the upper part of the wheel, are four in number and are provided so as to access the fixing screws or pins (not represented) for the control head. In the present variant, these fixing screws have their head housed in holes 102 in the connector 62 and their rod screwed into the base of the body 66 of the control head 14.

It will be appreciated that the holes 100 in the wheel and the holes 102 in the connector 62 are disposed so that they coincide only when the angular position of the wheel 88 is that which corresponds to the active position of the locking means, the holes 102 therefore being hidden by the wheel 88 in the other positions. It is therefore not possible to remove (and therefore fit) the control head 14 if the locking means is not active, a worthwhile safety criterion for users.

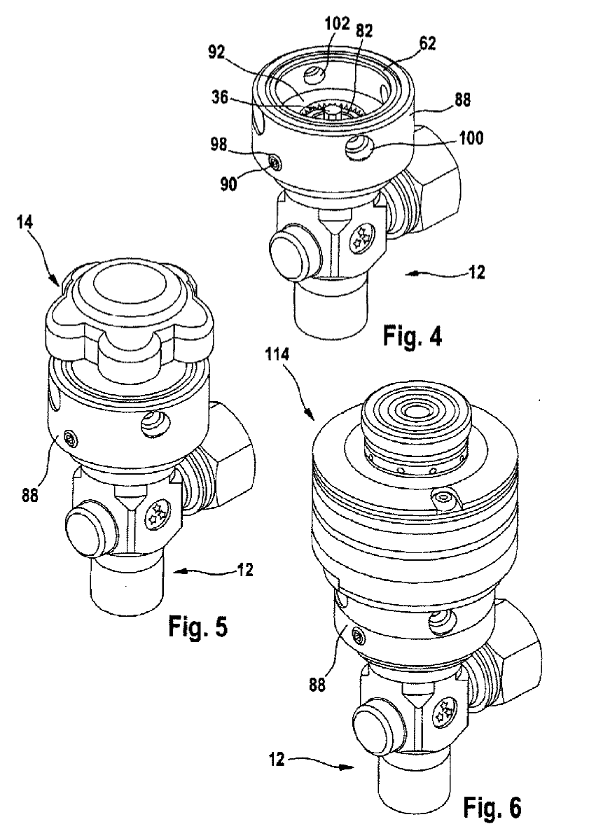

When the present valve 10 is fitted onto a pressurized gas cylinder, the control head 14 is normally removed in the following manner. The valve 34 is placed in the closure position on its seat 30 by actuating the wheel 74. Thereafter, the locking wheel 88 is rotated into the active position, so as to abut the sleeve 82 against the shoulder 86 of the valve rod 36. In this position of the locking wheel 88, the holes 100 and 102 coincide, allowing access to the screws for fixing the control head 14 as illustrated in FIG. 5. The fixing screws can therefore be unscrewed and withdrawn, thus detaching the body 66 from the control head 14 of the connector 62. To withdraw the control head 14, it then suffices to rotate it around itself, so as to uncouple the control rod 60 from the valve rod 36. FIG. 4 illustrates a view in perspective of the valve body 12 minus control head, with the wheel 88 in the position for activating the locking of the valve 34.

It should be noted that the exterior sealing of the valve chamber 24, here ensured by a flexible membrane, makes it possible to prevent the gas located in the chamber 24 or more generally in the gas passage from escaping to the air when the control head 14 is removed. Additionally, as seen in the figures, the tie achieved by the separable rigid coupling between the control rod 60 and the valve rod 36 is achieved outside the chamber 24 so that this link is not located in the zone wetted by the gas. By virtue of this configuration, it is possible to remove the control head without any risk of toxic gas escaping to the outside, therefore without any risk to the operator.

Once the manual control head 14 has been detached, it is of course possible to refix it to the valve body 12, fix another manual head thereto, or indeed a remotely controlled head, for example of the pneumatic type. It will be understood that the actuating principle of the control head does not come into play per se, the criteria for mounting the control head being simply that the geometry of the base of the head fits the connector 62 so as to be fixed therein by the fixing screws through the holes 100 and 102, and that the control rod can be coupled up to the valve rod 34.

An exemplary control head 114 with pneumatic actuation mounted on the valve body 12 is illustrated in FIG. 3, FIG. 6 showing a perspective view. The control head 114 comprises, like the manual head 14, a body 116 which is housed in the connector 62 and an axial control rod 118 able to be coupled up to the valve rod 36. Accordingly, the lower end of the control rod 118 comprises a cylindrical housing 120 furnished with a thread onto which the thread of the upper end of the valve rod 36 will be screwed. The valve 34 is thus tied and therefore necessarily follows the displacements of the control rod 118.

Such a control head 114 is mounted by positioning the head so as to engage the upper end of the valve rod 36 in the housing 120 and then screwing these together to couple them, by rotating the head around itself. At the same time as the valve rod 36 penetrates into the housing 120, the body 116 of the control head 114 penetrates into the connector 62. The rotation of the head 114 is stopped when the holes for the fixing screws in the body 116 are aligned with the holes 102 of the connector 62, then the head 114 is immobilized by screwing the fixing screws into the body 116. The control head 114 is then linked up to a pneumatic control hose (not represented) and the wheel 88 is rotated so as to place the sleeve 82 in the rest position, thus freeing the valve 34.

The actuating principle of the control head 114 is conventional. The control rod 118 can move axially in the body 116, and thus controls the position of the valve 34 with respect to its seat 30. A cover 122 is screwed onto the body 116. Three piston assemblies are stacked in the body 116. Each piston assembly comprises a piston 124 that can slide axially in the body 116 and a fixed partition 126, the space between each respective piston 124 and partition 126 forming a pressure chamber 128. The pistons 124 are spaced out along the control rod 118 and secured to the latter. Spring means 130 taking the form of a stack of Belleville washers, are disposed in a housing 132 in the cover and bear on the latter and on the first piston 124, creating a prestress. The pistons 124 being secured to the control rod 118, the force exerted by the Belleville washers 130 is transmitted to the control rod 118, thereby tending to push the valve rod 36 and therefore the valve 34 downwards on its seat 30, thus forming a so-called “normally closed” valve. Fluid intake paths are arranged in the control rod 118 to introduce a pressurized fluid, typically compressed air, into the pressure chambers 128 (the central fluid channel 134 only being shown in FIG. 3). The valve 10 can be opened by injecting air compressed into the pressure chambers 128 so as to exert on the pistons 124 a force greater than the elastic force of the Belleville washers, thus causing the upward displacement of the control rod 118. Because of the coupling in the housing 120, the valve rod 36 follows the movement of the control rod 118 and separates the valve 34 from its seat 30, allowing gas flow in the passage 22. It will be noted that the coupling serves here simply to transmit an axial force since there is no rotation of the control rod 118, unlike the case of the manual control head of FIG. 1.

In order to avoid a downward displacement of the control rod 118 under the action of the Belleville washers 130 when the control head 114 is not mounted on the valve body 12, the control head 114 advantageously comprises a system for locking the Belleville washers. In the variant of FIG. 3, this system comprises a lock-nut 136 placed on an outside thread of a pneumatic union 140 screwed onto the control rod 118. The union 140 communicates with the central channel 134 in the control rod 118.

Typically, the Belleville washers 130 will be pre-compressed in the factory, during assembly of the control head 114. Accordingly, the control head 114 is pressurized, thereby causing the upward displacement of the rod 118. The operator can thereafter manually rotate the lock-nut 136 on the thread of the union 140 so as to lower the lock-nut 136 and bring it into stop member against the cover 122. When the pressure is relaxed, the rod 118 remains locked in the up position and the Belleville washers 130 compressed.

To free the Belleville washers 130 compressed by the lock-nut 136 during the first use, when the head has been mounted on the valve body 12, pressure is raised in the head and the lock-nut 136 is unscrewed so as to return it to the position of FIG. 3. When subsequently removing and refitting the head, the same procedure will be adopted, that is to say the lock-nut 136 is manipulated when the head 114 is pressurized (thus limiting the friction).

In the preferred variant illustrated in the figures, the seat is of the normal (or direct) type, that is to say the pressure in the cylinder tends to separate the valve from its seat. When locking the valve 34, the sleeve 82 is displaced towards the seat 30 so as to exert a pressure force towards the sealing seat 30 by bearing on the shoulder 86.

Such a locking means is entirely transposable to the case of a valve body with inverted seat, for which the pressure in the cylinder tends to repel the valve onto the sealing seat and therefore to close the passage. In this case, the activation of the locking would correspond for example to moving the sleeve axially away from the sealing seat so as to bear on a shoulder of the valve rod and exert a force in the direction in which the gases exit, therefore preventing the possibility of the obturating member being activated in the opening direction.

Finally, the valve body could comprise a membrane instead of the valve 34. In this case, the closing of the sealing seat nevertheless involves the application of a obturating member (often not tied to the control rod) on the membrane so as to thrust it against the sealing seat. It is therefore possible to use a locking means of the type of that described above in the case of the direct seat, the locking means cooperating with the obturating member.

1. A valve, namely for pressurized or liquefied gas cylinder, comprising: a valve body comprising a gas flow passage extending between an inlet port and an outlet port;
a sealing seat in a valve chamber in said valve body passage and with which a obturating member is associated;
a control head mounted on said valve body and comprising an axial control rod cooperating with said obturating member to move it between a closure position in which it rests on said sealing seat so as to block the flow in said passage and an opening position in which the obturating member is parted from said sealing seat to allow flow;
wherein said control head is mounted in a removable manner on said valve body; and
a locking means comprising a stop member that is mobile outside the gas flow passage is integrated into said valve body and allows the locking of the obturating member on said sealing seat when said control head is removed from said valve body.

2. The valve as claimed in claim 1, wherein said chamber comprises an exterior sealing means.

3. The valve as claimed in claim 1, wherein the locking means can be maneuvered between an active position in which the obturating member is locked on said sealing seat and a rest position in which the obturating member can be parted from said sealing seat.

4. The valve as claimed in claim 3, wherein said locking means is designed in such a way that the control head can be removed only when the locking means is in the active position.

5. The valve as claimed in claim 1, characterized by a coupling which is rigid in the axial direction and separable, between said control rod and said obturating member.

6. The valve as claimed in claim 5, wherein:
the obturating member comprises a valve member fixed at the end of a valve rod guided axially with respect to the sealing seat in a longitudinal bore; and
said valve rod comprises at its end opposite from said valve an outside thread which cooperates with a thread in a cylindrical housing of the control rod.

7. The valve as claimed in claim 1, wherein said stop member is mobile axially outside of the gas flow passage.

8. The valve as claimed in claim 1, wherein said stop member is shaped as a sleeve coaxial with the direction of actuation and comprises on its exterior lateral surface a thread cooperating with a thread on a fixed part of said valve body.

9. The valve as claimed in claim 8, wherein said locking means comprises a wheel surrounding the valve body on the side of the control head and coupled to said stop member, so that the rotation of said wheel causes the axial displacement of said stop member.

10. The valve as claimed in claim 9, wherein said wheel is secured to a splined crown in the valve body, said splined crown engaging with splines provided on the external peripheral surface of said stop member.

11. The valve as claimed in claim 10, wherein said wheel is secured to said splined crown by way of screws which pass through the valve body at the level of guidance slots which define the travel of said wheel around the valve body.

12. The valve as claimed in claim 11, wherein said valve body comprises a connector-like piece receiving said control head; and in that said wheel surrounds said connector-like piece, said splined crown being placed, and the guidance slots provided, in the connector-like piece.

13. The valve as claimed in claim 12, wherein the control head is fixed in a removable manner to said connector-like piece.

14. The valve as claimed in claim 13, wherein said connector-like piece is made as an integral piece of the valve body, or added on.

15. The valve as claimed in claim 1, wherein the control head is of the manually or remotely actuated type.

16. The valve as claimed in claim 1, wherein the control head is of the pneumatic type with prestress springs, and in that the control head comprises a locking mechanism for locking said prestress springs in a compressed position.

17. The valve as claimed in claim 9, wherein said wheel of the locking system comprises a series of openings which are positioned so that in the active position, these openings are aligned with means for fixing the control head to the valve body, so as to allow access to these fixing means and allow the removal of said control head, and so as to hide these fixing means in the rest position.

18. The valve as claimed in claim 1, wherein the valve body is of the direct or inverted seat, or membrane type.

19. The use of the valve as claimed in claim 1 as cylinder valve or as flow valve in a gas distribution pipeline.

20. A valve body comprising:
a gas flow passage extending between an inlet port and an outlet port;
a sealing seat in a chamber in said valve body passage and with which a obturating member is associated;
fixing means for a control head with axial control rod, said obturating member being able to cooperate with said axial control rod for its displacement between a closure position in which it rests on said sealing seat so as to block the flow in said passage and an opening position in which the obturating member is separated from said sealing seat to allow flow;
wherein
a locking means integrated into the valve body and comprising a stop member that is mobile outside the gas flow passage, allowing the locking of the obturating member on said sealing seat when said control head is not fixed to the valve body.
